(19) United States
(12) Patent Application Publication
(10) Pub. No.: US 2011/0123508 A1
(43) Pub. Date: May 26, 2011

(54) INSTRUMENT CLEANER

(75) Inventors: Steven Kritzler, New South Wales (AU); Alex Sava, New South Wales (AU)

(73) Assignee: NOVAPHARM RESEARCH (AUSTRALIA) PTY. LTD., ROSEBERY, NEW SOUTH WALES (AU)

(21) Appl. No.: 12/991,842

(22) PCT Filed: May 6, 2009
(86) PCT No.: PCT/AU09/00564

§ 371 Date: Nov. 9, 2010

(30) Foreign Application Priority Data
May 9, 2008 (AU) 2008902264

(51) Int. Cl. A01N 63/02; A01P 1/00

(52) U.S. Cl. 424/94.2; 424/94.63

(57) ABSTRACT

A composition or concentrate for cleaning medical or dental instruments comprising in combination a protease and a biostatically effective phenoxy alcohol such as phenoxyethanol selected such that at a working solution dilution of the combination, the phenoxy alcohol is at a concentration below the MIC of the selected phenoxy alcohol against Pseudomonas aeruginosa (ATCC 15442), and wherein the combination is nevertheless effective to reduce a 6 log concentration of Pseudomonas aeruginosa (ATCC 15442) by at least a 1 log concentration within 4 hours. The composition or concentrate may further include or more hydrolases and or boron or a boron compound. The composition may be used in methods for cleaning a soiled medical or dental instrument, for example in an ultrasonic bath.

### FIELD OF THE INVENTION

The reprocessing of instruments in the clinical environment presents many challenges. Instruments must be assuredly clean, sterile and safe for re-use without risk of cross-infection to patients and staff. Dental instruments in particular are liable to become fouled in use with an insoluble matrix which is particularly difficult to remove thereby negating cleanliness, sterility and safety. The present invention provides a composition and method for cleaning such instruments. The invention is described primarily in relation to dental instruments but is not limited to such and is suitable for cleaning other instruments fouled with similarly intractable soils, for example certain medical and scientific instruments as well as food processing equipment.

### BACKGROUND OF THE INVENTION

The types of soils that are encountered include biological, (eg saliva, protein, blood, lipids, bacteria), organic (eg polymeric restoratives) and inorganic (eg amalgams). Further, the possible combinations of soil and substrate vary from loose attachment to a flat surface such as a stainless steel scalpel, to a glue-like physico-chemical adhesion with carbon steel. Even more difficult to remove are biological and non-biological matrices which have adhered to intricately detailed surfaces such as those exhibited by diamond burs.

Soil adhesion can be increased through heat such as caused by friction in the case of rotary tools, or by autoclaving inadequately cleaned instruments, resulting in the denaturation and fixing of proteins. By way of example, burs are often used at high speeds, for example 30,000 rpm, and may reach temperatures of 200° C., the bur grooves becoming blinded with a paste of bone/tooth, blood, saliva, composite and amalgam fillings which becomes baked into the grooves. A number of Health authorities worldwide (e.g. Decreto Legislativo Sep. 28, 1990: Norme di protezione dal contagio professionale da HIV nelle strutture sanitarie ed assistenziali pubbliche e private. Gazzetta Ufficiale Repubblica Italiana 1990; 235:78e80) require the immediate decontamination of instruments that were in contact with blood as a measure against HIV. Such decontamination often is performed with chlorine bleaches, phenols, QUATs and other agents that might further fix proteins on the instruments

This variability in types and combinations of soils poses a significant challenge in the formulation of satisfactory cleaning compositions.

It is widely accepted that an instrument which is not clean cannot be assuredly sterilised. For this reason, instrument reprocessing must involve an effective cleaning step prior to terminal sterilisation (in most dental clinics, by autoclave). Therefore, for assured sterilisation, cleaning must be of absolute best practice.

Public Health Authorities worldwide (e.g. Robert Koch Institute Recommendations. Hygienic Requirements for Processing of Medical Devices. Bundesgesundheitsblatt-Gesundheitsforschung-Gesundheitsschutz 2001; 44:1115-1126) impose strict requirements for the cleaning steps of instrument reprocessing. Of particular relevance to Dental clinicians is the requirement that endodontic tools be single use, unless a validated cleaning method is used. Such assured validated cleaning is acknowledged in the literature as problematic (Smith, A., Letters, S., Lange, A., Perrett, D., McHugh, S., Bagg, J., 2005. Residual protein levels on reprocessed dental instruments. Journal of Hospital Infection, 61, 237-241; F. Tessarolo et al. Different Experimental Protocols for Decontamination Affect the Cleaning of Medical Devices. A Preliminary Electron Microscopy Analysis Journal of Hospital Infection (2007) 65, 326-333).

Hitherto cleaning has generally involved the use of a detergent in an aqueous solution, either in a soaking bath or ultrasonic bath, with or without hand brushing/scrubbing (Bagg, J., Sweeney, C. P., Roy, K. M., Sharp, T., Smith, A., 2001, Cross infection Control Measures and the Treatment of Patients at Risk of Creutzfeldt Jakob Disease in UK General Dental Practice. British Dental Journal, 191(2), 87-90).

While hand brushing and scrubbing may invoke some confidence, it must be noted that according to AS4815:2006, scrubbing utensils must be non-abrasive (with the apparent exception of wire brushes for cleaning dental burs). Neither brushing, nor scrubbing achieves thoroughly uniform reproducible cleaning of hard-to-reach surfaces—and cannot be the only parameter for assured, validated cleaning. The use of ultrasound imposes the further requirement that cleaning compositions must be effective under conditions of sonication, especially in respect to the re-deposition of soils.

It is further highly desirable that the detergents used for cleaning possess either bacteriostatic or bactericidal properties in order to prevent the colonisation of soaking baths by microorganisms. Many acceptable biocides act by denaturing and fixing proteins and hence cannot be used in cleaning compositions.

Instrument detergents with biocidal properties are so clearly desirable that medical personnel have been known to use cationic-based detergents for cleaning medical instruments contrary to cautions in guidelines (ISO 15883, AS4187) (Smith, A., Bagg, J., McHugh, S., 2006. No to Chlorhexidine (Letter to Editor), British Dental Journal, 200, 31-31). It has also been reported that some UK clinics have employed cationic surgical handwash as a cleaning concentrate in soak and sonic baths (Bagg et al, 2006, supra).

It is widely acknowledged that proteins usually present the greatest challenge to the removal of biological soil. To remove proteins efficiently cleaners should contain proteases often in combination with amylases and lipases to efficiently cleave lipo- and glycoproteins. Combining biocides and enzyme proteins in one formulation presents a formidable formulation challenge. U.S. Pat. No. 6,235,692: “Foaming Enzyme Spray Cleaning Composition and Method of Delivery” achieves this by using antimicrobials “compatible with enzymes” that are formulated to be applied undiluted.

It is also very advantageous to formulate the cleaner as a dilutable (at least 1:100) composition, i.e. a concentrate.

There are a few currently available cleaners that claim biostatic properties. Endozyme AW (Ruhoff) contains ˜10% isopropanol. This isopropanol in the product denatures proteins causing loss of enzymatic activity on storage and consequently a decrease in cleaning efficacy.

Several Occupational Health and Safety (“OH&S”) issues relating to staff arise during instrument reprocessing. Standards warn against the formation of aerosols and the exposure of staff to cleaning agents (AS4815:2006) suggesting that manual scrubbing of instruments is best minimised or eliminated. The present inventors have observed that wire-brushing and scrubbing may spread droplets for up to 10 metres from the point of cleaning.

Ultrasonic and soaking baths should be regularly emptied and refilled with fresh cleaning solution. While standards vary from region to region (Aus, US, UK NHS), nowhere is the use of a fresh cleaning solution prescribed for every batch of soiled instruments processed in dental surgeries. A solution may be reused for many batches of instruments for four hours in Scotland to one day in Australia (NHS, Scotland, 2003, AS4815:2006). In the worst cases, clinics have reportedly had intervals of more than five days between changes of ultrasonic bath solution (Bagg et al, 2006, supra). The current inventors observed bacterial levels of 10E+7-10E+10 cfu/ml in ultrasonic baths at the end of 8-hour dental clinic workday. It is not surprising to find such high bacterial populations when one takes into account that the bath conditions closely resemble those employed to incubate bacteria—dark, aqueous, containing copious nutrients with temperatures in the approximate range of 35-40° C.

There is no current requirement to disinfect/sanitise baths between refills. Thus a significant number of bacteria could be carried over from previous cycles of use. This is exacerbated by ultrasonic baths built with drain outlets fitted with draining tubes which are hard-to clean. Worse still, when a nurse or technician is forced to empty larger ultrasonic baths there is a high risk of spillage and accidental human contact with the contents.

Australian, US and UK standards recommend that judgement be shown with regard to cleaning a visibly soiled bath, and that gross contamination should be removed from instruments prior to cleaning. Soiling levels can be easily underestimated, while even in the best case, pathogenic organisms and their colonies not visible to the naked eye will cross infect the bath and other instruments therein and multiply in situ creating an infection hazard to both subsequent patients and for staff.

While cleaning products are not required to disinfect instruments, effective antibacterial or bacteriostatic properties can limit the risk of cross-infection of instruments and staff infection and contribute to the general hygiene of the cleaning area in dental offices.

Another issue to be considered is the possible transmission of vCJD via reusable medical instruments. In the dental literature, this risk has been associated with the use of endodontic files during root canal therapy, due to the intimate contact with peripheral branches of the trigeminal nerve (Smith, A., Dickson, M., Aitken, J., Bagg, J., 2002, Contaminated dental instruments. Journal of Hospital Infection, 51, 233-235). It is widely accepted that autoclave cycles cannot reliably denature or deactivate prion proteins (Taylor, D. M., 1999, Inactivation of prions by physical and chemical means. Journal of Hospital Infection, 43(Supp), S69-S76). Therefore an instrument cleaning formulation which can deactivate prion infectivity during a cleaning cycle is extremely desirable.

It is acknowledged that efficient cleaning of instruments is believed to be a key step in reducing the risks of onward transmission of vCJD (Bagg, 2006, supra). Parashos states “.current concern over the risk of prion disease has contributed to the view that consideration should be given to treating endodontic instruments as single use”.

In summary, Dental instruments are expensive and not considered disposable, but to date no satisfactory method of cleaning them exists. Currently they are brushed, pre-cleaned in an ultrasonic bath, steam sterilized, and reused. However in most cases burs and some other complex dental instruments are likely to retain soil after even best practice cleaning and are potential carriers of prions (which are not inactivated by steam sterilization). Similar problems have been identified with a number of surgical instruments especially those not capable of being heated for sterilization or those in which sterilization resistant prions may be harboured within a biofilm matrix which cannot be removed by acid, alkali or enzyme treatments, with or without ultrasound. It is also widely acknowledged that the current practice of long cycles of use of cleaning solutions in ultrasonic and soak baths presents a hazard from both cross-infection and general OH&S hazard points of view.

Any discussion of the prior art throughout the specification should in no way be considered as an admission that such prior art is widely known or forms part of common general knowledge in the field.

### OBJECT OF THE INVENTION

It is an object of the present invention to overcome or ameliorate at least one of the disadvantages of the prior art, or to provide a useful alternative.

More particularly, it is an object of the present invention to provide improved compositions and methods for cleaning dental and medical instruments, and especially instruments which are soiled with matrices.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

### BRIEF STATEMENT OF INVENTION

According to a first aspect the invention provides a composition for cleaning medical or dental instruments comprising in combination a protease and a biostatically effective phenoxy alcohol selected such that at an appropriate working solution dilution of the composition, the phenoxy alcohol is at a concentration below the MIC of the selected phenoxy alcohol, and wherein the combination is nevertheless effective to reduce a 6 log concentration of Pseudomonads aeruginosa (ATCC 15442) to at least a 5 log concentration within 4 hours.

In accordance with the first aspect, the present invention provides a composition for cleaning medical or dental instruments including a protease and a biostatically effective phenoxy alcohol at a concentration below its MIC against Pseudomonads aeruginosa (ATCC 15442), wherein the composition is effective to reduce a 6 log concentration of Pseudomonads aeruginosa (ATCC 15442) by at least a 1 log concentration within 4 hours.

Also in accordance with the first aspect, the present invention provides a composition for cleaning medical or dental instruments including a protease and a biostatically effective phenoxy alcohol at a concentration below its MIC against Staphylococcus aureus (ATCC 6538), and wherein the composition is effective to reduce a 6 log concentration of Staphylococcus aureus (ATCC 6538) by at least a 1 log concentration within 4 hours.

In preferred embodiments the combination is effective to reduce a six log concentration of pseudomonads to below a 4 log concentration within 4 hours and is at least as effective against Staphylococcus aureus (ATCC 6538), that is, in preferred embodiments the combination is effective to reduce a six log concentration of Staphylococcus by at least a 2 log concentration within 4 hours.

In preferred embodiments the selected phenoxyalcohol is phenoxyethanol and it is present in a concentration of greater than 10,000 ppm, and preferably greater than 30,000 ppm, in a stable concentrate intended for dilution by at least 100:1

Hitherto, phenoxyethanol has been used as a fungicide or biostat. As such, it has been used at a concentration of 15,000 ppm, slightly exceeding its Minimum Inhibitory Concentration (“MIC”) against a resistant bacteria, Staphylococcus aureus (ATCC 6538) of 10,000 ppm. MIC in microbiology is defined as “the lowest concentration of an antimicrobial that will inhibit the visible growth of a microorganism after overnight incubation”. When present at less than the MIC, phenoxyalcohol will not prevent the multiplication of microorganisms. It is generally accepted that the range of MIC's for phenoxyethanol ranges from 2,500 ppm against Aspergillus niger (ATCC 16404) to 10,000 ppm against Staphylococci. (Phenoxetol A Universal Solution. Clariant)

According to a second aspect the invention provides a composition according to the first aspect comprising a concentrate including a protease and a biostatically effective phenoxyalcohol in a concentration such that upon dilution to a working concentration the phenoxy alcohol is at a concentration below the MIC of the selected phenoxy alcohol, and wherein the combination at the working concentration is nevertheless effective to reduce a 6 log concentration of Pseudomonas aeruginosa (ATCC 15442) by at least 1 log within 4 hours.

In accordance with the second aspect, the invention also provides a concentrate including a protease and a biostatically effective phenoxyalcohol that upon dilution provides a composition according to the first aspect.

In preferred embodiments of the invention according to the second aspect the phenoxyalcohol is phenoxyethanol and is present in the concentrate in concentrations in excess of 10,000 ppm, more preferably in excess of 30,000 ppm. The concentrate is intended to be diluted by 100:1 prior to use. The concentrate when diluted not only enables instruments to be cleaned in an ultrasonic bath to a standard which cannot be achieved by existing cleaners under the same conditions, but also lowers the concentration of micro-organisms in the bath. The invention is not limited to use in ultrasonic baths and the composition is effective when used as a soak or cleaning solution applied by other means.

According to a third aspect the invention provides a composition according to the first aspect further comprising one or more hydrolases.

(Hydrolases are classified as EC 3 in the EC number classification of enzymes. Hydrolases can be further classified into several subclasses, based upon the bonds they act upon:
EC 3.1: ester bonds (esterases: nucleases, phosphodiesterases, lipase, phosphatase)
EC 3.2: sugars (glycosylases/DNA glycosylases, glycoside hydrolase)
EC 3.3: ether bonds
EC 3.4: peptide bonds (Proteases/peptidases)
EC 3.5: carbon-nitrogen bonds, other than peptide bonds
EC 3.6: acid anhydrides (acid anhydride hydrolases, including helicases and GTPase)
EC 3.7: carbon-carbon bonds
EC 3.8: halide bonds
EC 3.9: phosphorus-nitrogen bonds
EC 3.10: sulfur-nitrogen bonds
EC 3.11: carbon-phosphorus bonds
EC 3.12: sulfur-sulfur bonds
EC 3.13: carbon-sulfur bonds

According to a fourth aspect the invention provides a composition according to any one of the preceding aspects further comprising boron or a boron compound.

According to a fifth aspect, the invention provides a composition according to any one of the preceding aspects capable of cleaving infectious prion proteins into non-infectious peptides.

It will be understood that although the invention is herein described primarily with respect to the use of phenoxyethanol as the phenoxyalcohol other phenoxyalcohols such as the phenoxy methanol or propanol or longer chain substituent alcohols may be used. Phenoxy di-alcohols may be employed. The phenoxy group may have other substituents. Those skilled in the art will be able to determine suitable phenoxy alcohols by simple experiment based upon the teaching herein.

According to a sixth aspect the invention provides a method for cleaning a soiled medical or dental instrument comprising the step of exposing the soil to a solution according to any of the preceding aspects

### BRIEF DESCRIPTION OF THE DRAWINGS

FIG. 1 is a graph showing the effect of diluted compositions of the present invention in reducing the concentration of Bacterial population of Pseudomonas aeruginosa ATCC15442 over time in comparison with diluted market leading enzymatic cleaner products.

FIG. 2 is a graph showing the effect of diluted compositions of the present invention in reducing the concentration of Staphylococcus aureus ATCC 6568 over time in comparison with diluted market leading enzymatic cleaner products.

FIG. 3 is a graph showing the effect of diluted compositions of the present invention in reducing the concentration of Streptococcus mutan over time in comparison with diluted market leading enzymatic cleaner products.

FIG. 4 is a photograph of a bur after treatment with Empower at a dilution of 1:100 with clearly visible debris on the surface of the instrument.

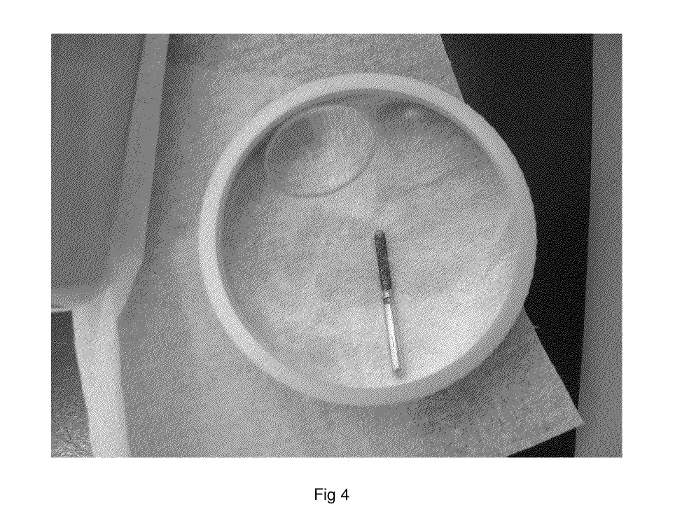

FIG. 5 is a photograph showing that Formulation B at the same dilution rate as Empower completely removes all visible soil.

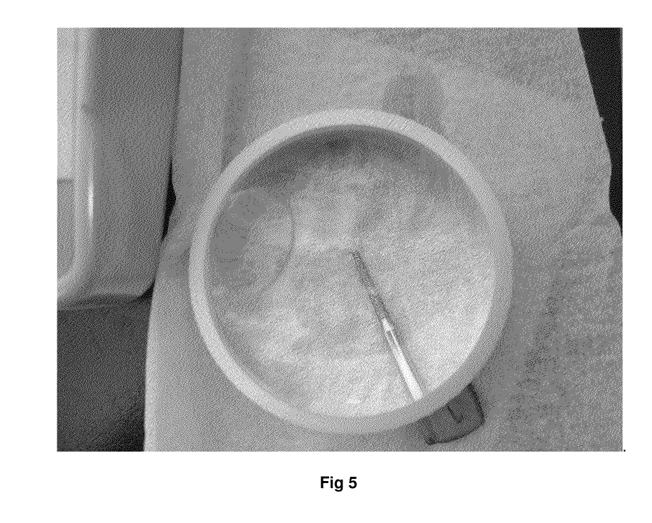

FIG. 6 shows the results of the cleaning efficacy test conducted with reference to table 1.

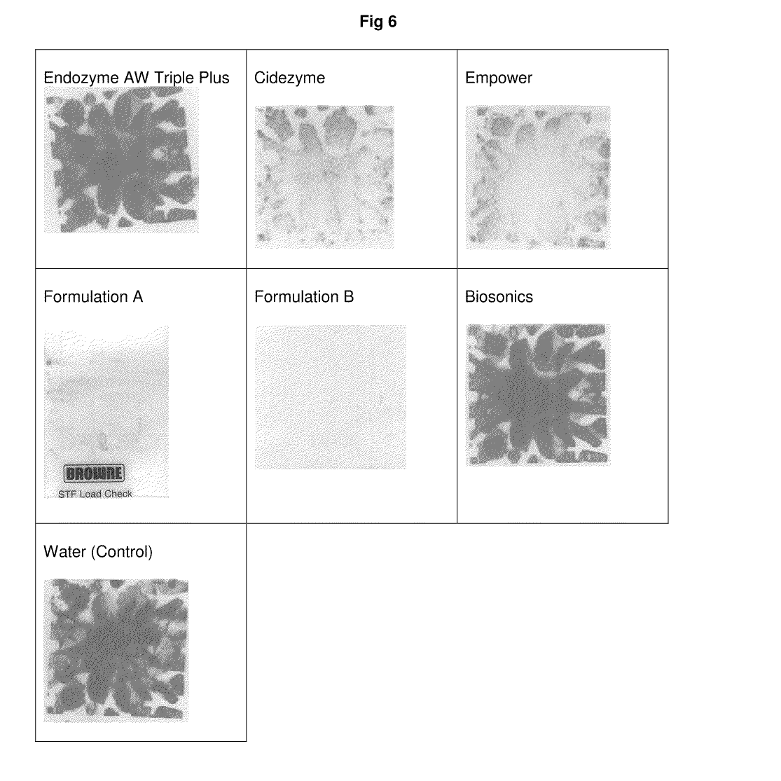

FIG. 7 is a Western Blot of PrP-res prion protein (M1000 strain) after exposing to Formulation 2. The intensity of the PrP-res signal is reduced by the all the dilutions tested.

### BEST METHOD OF PERFORMING THE INVENTION

The invention will now be more particularly described by way of example only with reference to specific examples.

As described earlier, standards in Australia and the UK recommend the changing of ultrasonic bath cleaning solution at daily or half-daily intervals, respectively. Given the inevitable and proven (Miller et al, 1993) contamination of used ultrasonic cleaning solution, a challenge test was developed to compare the antimicrobial efficacy of compositions according to the invention with market leading compositions hitherto used for cleaning dental instruments. The challenge involved three common strains of bacteria, together with organic and inorganic load.

### Materials and Methods.

### Formulation a According to the Invention

| | Wt/Wt % |
|---|---|
| Teric 168 (low foaming block co- | 7.0 |
| polymer non-ionic surfactant) | |
| Borax | 0.8 |
| Propylene glycol | 9.2 |
| Phenoxyethanol | 8.6 |
| Subtilisin Savinase 16L | 7.3 |
| Amylase Termamyl 300L | 1.3 |
| Perfume | 0.3 |
| Dye | 0.02 |
| Water | to 100 |

pH = 8.5

Formulation B according to the invention exemplifies a formulation for use by dental technicians:

| | Wt/Wt % |
|---|---|
| Sodium salt of dodecyl benzene | 11.5 |
| sulphonic acid | |
| Borax | 0.8 |
| Propylene glycol | 4.2 |
| Phenoxyethanol | 7.3 |
| Subtilisin Savinase 16L | 7.3 |
| Lipase Lipolase 100L | 0.1 |
| Cellulase Carezyme 4500L | 0.08 |
| Amylase Termamyl 300L | 1.3 |
| Perfume | 0.1 |
| Dye | 0.0048 |
| Water | to 100 |

pH = 8.5

Examples A & B were compared with four market leaders in the field of cleaning of dental instruments. These are EmPower™ (Kerr); Endozime™ AW Plus (Ruhof); Biosonic™ (Coltene) and Cidezyme™ (Johnson &Johnson).

The cleaners (Table 1) were diluted 1:100 in 100 ppm AOAC hard water. An organic load was added, consisting of 5% w/w Yeast extract (prepared as per the Australian TGO 54 procedure), 5% w/w defibrinated horse blood (Oxoid), and a mixture of Horse blood, egg yolk, mucin and albumin 10 mL (aliquots of each preparation were inoculated with 0.1 mL of respective bacterial inocula (approx. 10⁸ CFU/mL) (Table 2).

Samples were incubated at 40±1° C. for 24 hours. For each of the first 8 hours, a 10 minute sonication was included. 1 mL samples were extracted at 1, 4, 8 and 24 hour time points, and added to 9 mL of Tryptone Soya Broth with neutraliser (5% w/w Tween 80 (Sigma), 3% w/w Lecithin (Sigma), 0.1% w/w L-Histidine (Sigma) and 0.5% w/w Sodium thiosulphate (Sigma)). Neutralised sample was vortexed, serially diluted with Saline solution and quantified on Tryptone Soya Agar (Oxoid). Plates were incubated for 48 hours at 37±1° C.

TABLE 1

| No. | Name | Manufacturer | Batch # | Expiry |
|---|---|---|---|---|
| 1 | Test formulation | | | |
| | A according to | | | |
| | invention | | | |
| 2 | Test formulation | | | |
| | B according to | | | |
| | invention | | | |
| 3 | EmPower | Kerr | 2106510 | November 2007 |
| 4 | Endozime AW | Ruhof | | 2008 |
| | Plus | | | |
| 5 | Biosonic | Coltene | 6326 | October 2008 |
| 6 | Cidezyme | J&J | 71076 | April 2008 |

TABLE 2

| Bacteria | ATCC |
|---|---|
| Pseudomonas aeruginosa | 15442 |
| Staphylococcus aureus | 6538 |
| Streptococcus mutan | |

The above bacteria are recognised as challenging vegetative gram negative and gram positive bacteria. They are resistant organisms which are comparatively difficult to kill.

### Results

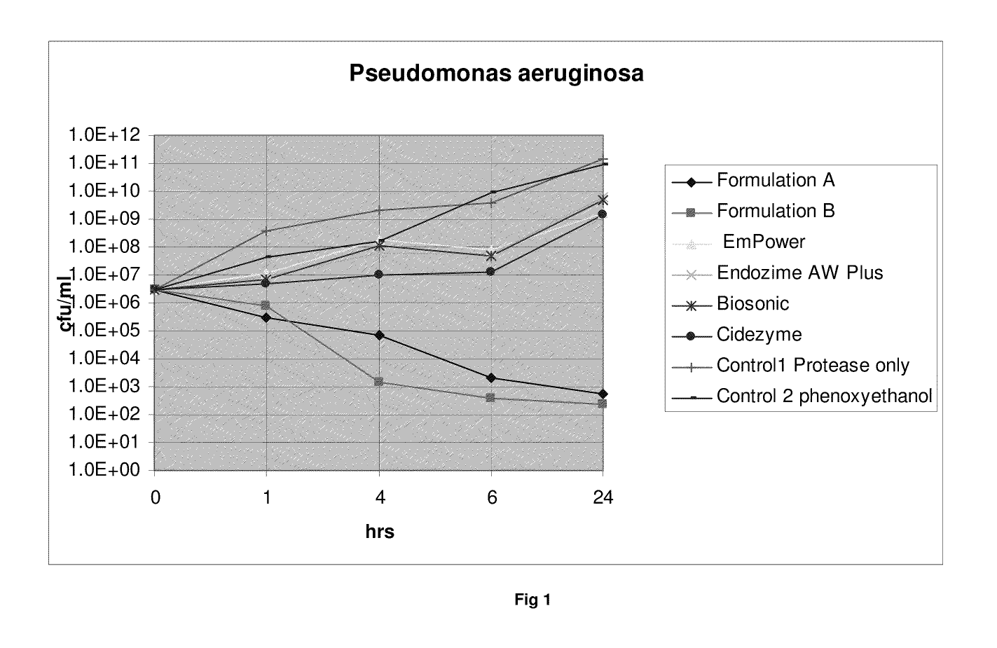

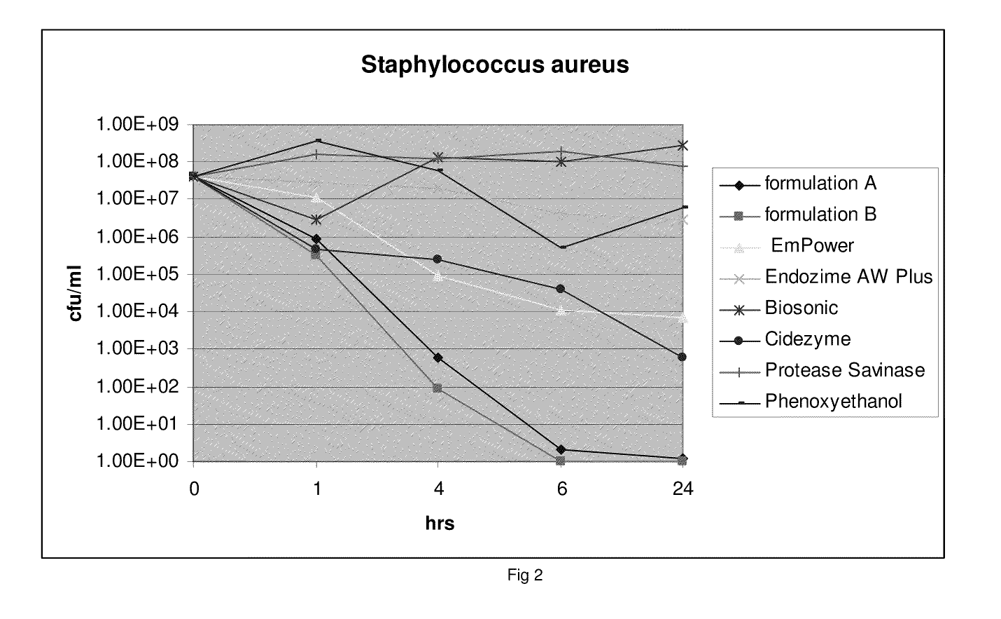

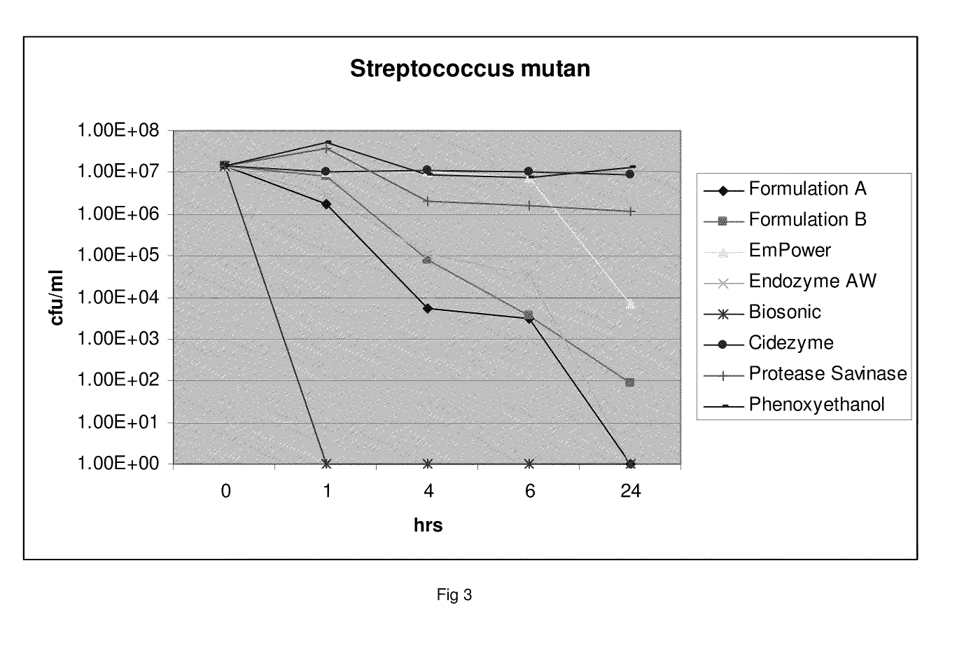

The results are shown in table 3a, 3b, 3c and appended FIGS. 1, 2, 3 respectively.

TABLE 3a
Change in Bacterial population of Pseudomonas aeruginosa
ATCC15442 after exposing to diluted enzymatic cleaners.

| | Concentration CFU/ml after time | | | | |
|---|---|---|---|---|---|
| composition | 0 hrs | 1 hr | 4 hr | 6 hrs | 24 hrs |
| Formulation | 2.94E+06 | 3.00E+05 | 7.30E+04 | 2.00E+03 | 5.62E+02 |
| A | | | | | |
| Formulation | 2.94E+06 | 7.60E+05 | 1.50E+03 | 4.00E+02 | 2.30E+02 |
| B | | | | | |
| EmPower | 2.94E+06 | 1.17E+07 | 1.83E+08 | 8.20E+07 | 1.70E+09 |
| Endozime | 2.94E+06 | 8.40E+06 | 5.80E+07 | 5.22E+07 | 6.00E+09 |
| AW Plus | | | | | |
| Biosonic | 2.94E+06 | 6.80E+06 | 1.13E+08 | 5.00E+07 | 5.10E+09 |
| Cidezyme | 2.94E+06 | 4.60E+06 | 1.06E+07 | 1.35E+07 | 1.44E+09 |
| Control1 | 2.94E+06 | 3.69E+08 | 2.06E+09 | 3.80E+09 | 1.46E+11 |
| Protease | | | | | |
| only | | | | | |
| Control 2 | 2.94E+06 | 4.11E+07 | 1.55E+08 | 8.34E+09 | 9.03E+10 |
| phenoxy- | | | | | |
| ethanol | | | | | |

TABLE 3b
Changes in the Bacterial population of Staphylococcus aureus
(ATCC 6538) after exposure to diluted enzymatic cleaners

| | Concentration CFU/ml after time | | | | |
|---|---|---|---|---|---|
| composition | 0 hrs | 1 hr | 4 hrs | 6 hrs | 24 hrs |
| formulation | 4.21E+07 | 9.01E+05 | 6.23E+02 | 2.10E+00 | 1.25E+00 |
| A | | | | | |
| formulation | 4.21E+07 | 3.26E+05 | 9.17E+01 | 1.00E+00 | 1.00E+00 |
| B | | | | | |
| EmPower | 4.21E+07 | 1.12E+07 | 8.86E+04 | 1.10E+04 | 6.77E+03 |
| Endozime | 4.21E+07 | 2.95E+07 | 2.03E+07 | 4.16E+06 | 2.96E+06 |
| AW Plus | | | | | |
| Biosonic | 4.21E+07 | 3.01E+06 | 1.30E+08 | 1.05E+08 | 2.82E+08 |
| Cidezyme | 4.21E+07 | 4.74E+05 | 2.39E+05 | 4.06E+04 | 5.89E+02 |
| Protease | 4.21E+07 | 1.58E+08 | 1.26E+08 | 2.00E+08 | 7.94E+07 |
| Savinase | | | | | |
| Phenoxy- | 4.21E+07 | 3.50E+08 | 6.04E+07 | 4.98E+05 | 6.00E+06 |
| ethanol | | | | | |

TABLE 3c
Change in Bacterial population of Streptococcus mutan
after exposing to diluted enzymatic cleaners

| | Concentration CFU/ml after time | | | | |
|---|---|---|---|---|---|
| composition | 0 hrs | 1 hr | 4 hrs | 6 hrs | 24 hrs |
| Formulation | 1.40E+07 | 1.80E+06 | 5.50E+03 | 3.20E+03 | 1.00E+00 |
| A | | | | | |
| Formulation | 1.40E+07 | 7.90E+06 | 8.00E+04 | 3.59E+03 | 9.00E+01 |
| B | | | | | |
| EmPower | 1.40E+07 | 1.05E+07 | 9.90E+06 | 7.60E+06 | 6.80E+03 |
| Endozyme | 1.40E+07 | 2.89E+06 | 1.06E+05 | 3.46E+04 | 1.00E+00 |
| AW | | | | | |
| Biosonic | 1.40E+07 | 1.00E+00 | 1.00E+00 | 1.00E+00 | 1.00E+00 |
| Cidezyme | 1.40E+07 | 1.00E+07 | 1.13E+07 | 1.00E+07 | 8.63E+06 |
| Control 1 | 1.40E+07 | 3.65E+07 | 2.00E+06 | 1.60E+06 | 1.16E+06 |
| Protease | | | | | |
| Savinase | | | | | |
| Control 2 | 1.40E+07 | 5.10E+07 | 9.00E+06 | 7.30E+06 | 1.30E+07 |
| Phenoxy- | | | | | |
| ethanol | | | | | |

As shown in FIG. 1, in the case of Pseudomonas aeruginosa (ATCC 15442), the initial concentration was 6 log. By the end of the first hour compositions 3 to 6 had increased concentrations of microorganisms. Thereafter the concentration of organisms continued to increase for 4 hours and was substantially greater after 24 hrs. In contrast both Formulations A and B according to the invention showed a 2 log reduction in microorganism concentration within 4 hours and the reduction continued throughout the 24 hour test. This is surprising since the concentration of phenoxyethanol in samples A & B is significantly below the MIC. Neither the protease nor the phenoxyethanol alone at these concentrations achieved a reduction. The results for the other organisms challenged were similar though less dramatic. Compositions A and B according to the invention were the only compositions which reduced micro-organisms by at least 1 log in each case within 4 hrs. Cidezyme and Empower did achieve some reduction with staph aureus over 4 hrs but it was less than 1 log and not nearly as great as the reductions achieved by compositions of the invention.

The compositions of the present invention were the only ones which were effective in each case in reducing the micro-organism population over time and showed the broadest spectrum of activity across the challenge species. Pseudomonads are ubiquitous and are the most resistant gram negative bacteria that are present in the potable water supply used to dilute cleaners. Staphylococcus aureus and Pseudomonas aeruginosa strains used in this study are routinely used to challenge hospital disinfectants (AOAC test methods) as they are the most resistant gram positive and gram negative bacteria, respectively.

Ultrasonic baths are normally operated closed. The conditions in a covered ultrasonic cleaning bath are ideal for bacterial growth—a dark, ˜40° C. environment with ample nutrients present as cleaned from soiled instruments. The majority of the products tested did not inhibit the growth of bacteria, with the bacterial population reaching log 10-log 11 cfu/ml levels.

It should also be noted that in many clinics, instrument brushing is performed after a pre-soak in the ultrasonic bath. The contaminated aerosol and droplets spread during such a procedure creates a significant OHS/infection risk.

The instrument reprocessing areas in some office settings do not have defined clean and dirty areas, thus such droplets could even contaminate the stored packs of sterilised instruments.

### Cleaning Efficacy

### Initial Screening Test—Cleaning Efficacy of Leading Products

A standardised soil test was used to screen the test products for cleaning efficacy, without the benefit of Ultrasonic energy. Browne STF “Load Check” test strips (Albert Browne Ltd., UK) are accepted as a reproducible and rigorous validation test for hospital washers. They consist of a surrogate soil, including two types of protein, one carbohydrate and one lipid.

### Materials and Methods

Six instrument cleaners (Table 1) were diluted 1:100 in 100 ppm synthetic AOAC hard water, at 40±1° C. 100 mL of each diluted Product solution was dispensed into a separate 120 mL glass beaker. Browne STF Load Check Indicators were prepared by cutting each strip in half, to yield two matching Browne STF squares. One square was placed in each beaker so that it stood upright against the wall of the beaker. A countdown timer started at 10 minutes.

After 10 minutes, the Browne STF square was removed from the beaker, carefully rinsed by submerging in clean water with minimal agitation, and placed on a dry, white paper towel for drying and photography.

The effectiveness of the cleaning product was measured as a function of the proportion of red surrogate soil removed.

### Results

Only Formulations A and B demonstrated an ability to completely remove the soil from the strip. Cidezyme (Johnson & Johnson) and EmPower (Kerr) also showed some effect, however it is apparent that of the seven products trialled, Formulation B alone was capable of removing a difficult surrogate medical soil challenge through the effectiveness of its formulation. The varying performance of the six other products indicates a reliance on mechanical cleaning forces (such as manual or ultrasonic “scrubbing”). Biosonic showed cleaning efficacy worse than water, alone.

Worst-Case Soil Comparison. Empower and Formulation B

Having determined that Formulation B passed the initial screening test for cleaning efficacy, and deciding that EmPower was the “best of the rest”, a worst case scenario—to the dental environment—was devised.

A “worst case” scenario needed to take into account both the substrate, and the soil applied, with respect to presenting a very difficult dental challenge to cleaning. At the same time the challenge needed to be realistic and the resulting protocols to take into account that only visual cleanliness is required site to achieve reliable sterilisation or disinfection.

After extensive consultations with dental technicians and analysis of the literature, diamond burs were selected as representative of the worst case instrument surface. Round head tungsten carbide and carbon steel burs have been widely used as a test substrate for artificial soils, however they proved easier to clean following standard protocols as they present a simpler cutting surface free of small occlusions and crevices.

Endodontic files have similarly been reported as difficult to clean. However, it was found that the shape of the file and use of stainless steel (a hydrophilic surface) presented a significantly lesser challenge to cleaning processes than diamond burs.

The elaborate surface of a diamond bur is completely random as it is covered in a fine mass of diamond powder and presented the most challenging surface for soil removal. Combined with frictional heat generation in-use, the potential for chemical adhesion of denatured proteinaceous is very high.

The test soil drew influence from many European standard test soils for medical washer disinfectors (prEN ISO 15883-1: 2002). It includes multiple sources of protein (blood albumin, egg yolk), mucosal carbohydrates (mucin) and lipids. It was adjusted to a low viscosity to allow penetration into the facets and crevices of the surface, and baked onto the substrate to denature proteins and increase adhesion.

### Materials and Methods

| | |
|---|---|
| Egg yolk | 10% w/w |
| 1% albumin | 10% w/w |
| 1% mucin | 10% w/w |
| Synthetic broth | 68% w/w |
| Solvent Blue #36 | 2% w/w |

The soil viscosity was adjusted to approximately 600 mPa·s to ensure soil penetration into the bur crevices.

Formulation B and Empower were tested in an ultrasonic bath at various dilution rates against diamond and carbon steel burs, as shown in Table 4. Controls were sonicated in 40° C. potable water.

### Results

The cleanliness of the burs after each treatment was qualitatively assayed on a scale of 0 to 10, with 10—complete visual removal of soils and 0—no appreciable removal. In parentheses—number of replicates treated.

TABLE 4

| Treatment | Formulation B | Empower | Water |
|---|---|---|---|
| 5 min sonication at | 10 (6) | 9 (6) | 6 (3) |
| 1:50 carbon steel burs | | | |
| 5 min sonication | 10 (6) | 7 (6) | 5 (3) |
| 1:50 diamond burs | | | |
| 5 min sonication at | 10 (3) | 7 (3) | 5 (3) |
| 1:100 carbon steel burs | | | |
| 5 min sonication | 10 (5) | 8 (4) | 5 (3) |
| 1:100 diamond burs | | | |

### Discussion

Having demonstrated the superiority of Formulation B in terms of “formulation based” cleaning efficacy, it was compared against its nearest rival (aggregated across both the antimicrobial and cleaning tests) Empower. When tested against a very difficult to clean soil, and with the assistance of ultrasound, Formulation B left no visible soil at the recommended use dilution. Empower was clearly better than water and ultrasound alone, however it left visible soiling in all cases.

Depositing a challenging quantity of artificial soil on diamond burs was easy due to complicated surface profile. In contrast, it was not possible to deposit a meaningful amount of soil on endodontic files, reamers and broaches even when using severe drying-baking modes—under these conditions instruments were visually clean after sonicating in Formulation B diluted 1:100 for 2 minutes.

Although in the compositions discussed above the protease and phenoxyethanol are present in equal proportions the proportions may vary considerably. Similar results have been obtained with ratios of enzyme to phenoxyethanol of from 2:1 to 1:2. The preferred formulation contains a mixture of enzymes such as an amylase, a lipolase, and possibly a cellulase rather than merely one protease. For preference a combination off water miscible solvents is included as is a detergent. Optionally perfumes and dyes may be added. Those skilled in the art will recognise that the relative amounts of such additions may also be varied over a wide range and will be aware of substitutes which may be employed without departing from the inventive concept herein disclosed.

The infectious prion protein cleaving efficacy of the invention was tested using methodology described in Victoria A. Lawson, James D. Stewart and Colin L. Masters Enzymatic detergent treatment protocol that reduces protease-resistant prion protein load and infectivity from surgical-steel monofilaments contaminated with a human-derived prion strain J Gen Virol 88 (2007), 2905-2914.

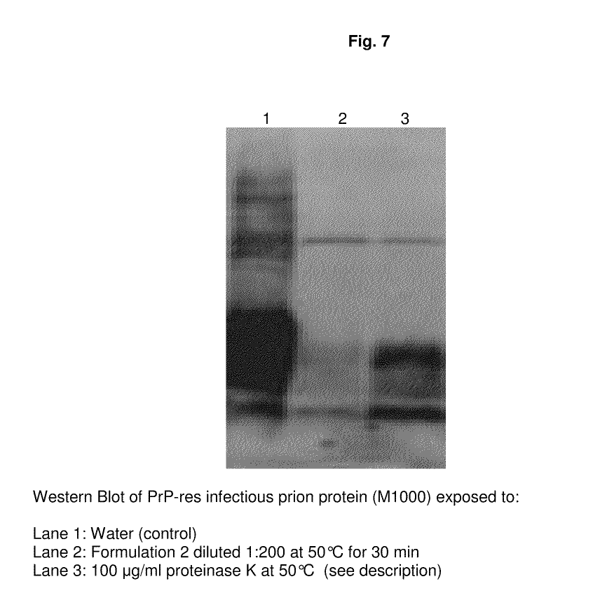

One microgram of 10% brain homogenate obtained from sick animal was added to 98 microlitres of 1:100 diluted formulation B at 50C. FIG. 7. summarised the results of the experiment. Even at this unfavourable ratio of enzymatic detergent to prion protein (100:1) the concentration of prion protein has decreased by at least 2.5 log. Since the practical ratio of the enzymatic detergent to prion protein is at least 10,000:1 one can expect proportional increase in cleaving rate of the infectious prion protein and complete removal of prion infectivity when medical instruments are treated with formulation B at recommended dilution rates and temperatures.

1. A composition for cleaning medical or dental instruments comprising in combination a protease and a biostatically effective phenoxy alcohol selected such that at a working solution dilution of the combination, the phenoxy alcohol is at a concentration below the MIC of the selected phenoxy alcohol against Pseudomonads aeruginosa (ATCC 15442), and wherein the combination is nevertheless effective to reduce a 6 log concentration of Pseudomonads aeruginosa (ATCC 15442) by at least a 1 log concentration within 4 hours.

2. A composition for cleaning medical or dental instruments including a protease and a biostatically effective phenoxy alcohol at a concentration below its MIC against Pseudomonads aeruginosa (ATCC 15442), wherein the composition is effective to reduce a 6 log concentration of Pseudomonads aeruginosa (ATCC 15442) by at least a 1 log concentration within 4 hours.

3. A composition according to claim 1 wherein the combination is effective to reduce a six log concentration of pseudomonads by at least a 2 log concentration within 4 hours.

4. A composition for cleaning medical or dental instruments including a protease and a biostatically effective phenoxy alcohol at a concentration below its MIC against Staphylococcus aureus (ATCC 6538), and wherein the composition is effective to reduce a 6 log concentration of Staphylococcus aureus (ATCC 6538) by at least a 1 log concentration within 4 hours.

5. A composition according to claim 4 wherein the combination is effective to reduce a six log concentration of Staphylococcus by at least a 2 log concentration within 4 hours.

6. A composition according to claim 1 wherein the combination is at least as effective against Staphylococcus aureus (ATCC 6538)

7. A composition according to claim 1 wherein the selected phenoxyalcohol is phenoxyethanol present in a concentration of greater than 10,000 ppm,

8. A composition according to claim 4 wherein phenoxyethanol is present in a concentration of 30,000 ppm or greater, in a stable concentrate intended for dilution by >100:1

9. A concentrate including a protease and a biostatically effective phenoxyalcohol in a concentration such that upon dilution to a working concentration the phenoxy alcohol is at a concentration below the MIC against Pseudomonads aeruginosa (ATCC 15442) of the selected phenoxy alcohol, and wherein the combination at the working concentration is nevertheless effective to reduce a 6 log concentration of Pseudomonas aeruginosa (ATCC 15442) by at least 1 log within 4 hours.

10. A concentrate including a protease and a biostatically effective phenoxyalcohol that upon dilution provides a composition according to claim 1.

11. A concentrate according to claim 9 wherein the phenoxyalcohol is phenoxyethanol and is present in the concentrate in concentrations in excess of 10,000 ppm.

12. A concentrate according to claim 11 wherein the phenoxyalcohol is phenoxyethanol and is present in the concentrate in concentrations in excess of 30,000 ppm.

13. A concentrate according to claim 9 wherein the concentrate is intended to be diluted by >100:1 prior to use.

14. A concentrate according to claim 9 further including one or more hydrolases.

15. A concentrate according to claim 9 further comprising boron or a boron compound.

16. A concentrate according to claim 9 capable of cleaving infectious prion proteins into non-infectious peptides.

17. A composition according to claim 1 when used in an ultrasonic bath.

18. A method for cleaning a soiled medical or dental instrument comprising the step of exposing the soil to a composition according to claim 1.

19. A concentrate according to claim 9 when used in an ultrasonic bath.

20. A method for cleaning a soiled medical or dental instrument comprising the step of exposing the soil to a composition according to claim 1.
